(19) United States
(12) Patent Application Publication
(10) Pub. No.: US 2026/0142951 A1
(43) Pub. Date: May 21, 2026

(54) METHOD FOR ENCRYPTED COMMUNICATION BETWEEN COMPUTER SYSTEMS, AND A VEHICLE

(71) Applicant: MERCEDES-BENZ GROUP AG, Stuttgart (DE)

(72) Inventor: Peiguo ZOU, Stuttgart (DE)

(21) Appl. No.: 19/481,703

(22) PCT Filed: Apr. 11, 2024
(86) PCT No.: PCT/EP2024/059759

§ 371 Date: Nov. 5, 2025

(30) Foreign Application Priority Data
May 8, 2023 (DE) 10 2023 001 848.1

(51) Int. Cl. H04L 9/40; H04L 9/06; H04L 9/30

(52) U.S. Cl. CPC H04L 63/0428; H04L 9/0631; H04L 9/302; H04L 9/3073

(57) ABSTRACT

Communication between computer systems are encrypted. Computer-readable data is exchanged using hybrid encryption methods. Only a single asymmetric key pair is used to encrypt the data to be exchanged between two computer systems using an asymmetric encryption method.

### BACKGROUND AND SUMMARY OF THE INVENTION

Exemplary embodiments of the invention relate to a method for encrypted communication between computer systems, as well as to a vehicle.

Machine learning is often used in practice to generate predictive models for applications such as image processing, speech and text recognition and the like. Large amounts of data are collected and processed over time. However, this massive data collection raises data protection concerns. It is therefore necessary to take appropriate measures to protect the privacy of users in connection with the generation of training data for machine learning. This applies in particular to so-called multi-party computation, in which a machine learning model is trained based on a large number of different user-generated data.

US 2020/0242466 A1 discloses a method for machine learning while preserving privacy. Here, private data secretly shared by several data clients is stored on K training computers. Values for a set of d weights W are initialized for a machine learning model, wherein the weights are shared secretly among the K training computers. The weights and the features are decimal values that are shifted and stored as integers. The disadvantage of this is that the differential data privacy can significantly affect the accuracy of the model by eliminating and quantifying the probability of information leakage.

Furthermore, U.S. Pat. No. 10,601,786 B2 discloses a privacy-preserving system for machine learning training data. The system discloses anonymizing sensor data to facilitate machine learning without revealing the identity of an associated user. During operation, the system receives sensor data encrypted by a key generator via a gateway server, wherein the encrypted sensor data includes a client identifier corresponding to an associated user or client device and is replaced by a device masked with an anonymized machine learning identifier. The disadvantage of this is that the key generator, the gateway server, and the device masker contain all security-relevant information, such as the keys generated for encryption and decryption, personal data and the aforementioned client identifier. This means that the key generator, the gateway server, and the device masker participate as third parties in the system, which must also be authorized and specially protected as trusted third parties. This increases the effort and represents a point of attack that must therefore be considered a weak point for data security.

Furthermore, US 2019/0113973 A1 discloses a system and method for collecting, analyzing, and sharing bio-signal and non-bio-signal data. This involves measuring a user's brain waves using EEG. Analysis of the brain waves allows patterns in the brain waves to be identified, which in turn are used to generate a cryptographic key. The cryptographic key can be used to encrypt and/or decrypt data, for example in an asymmetric encryption process. The data processed in this way is protected from unauthorized access by a username and password.

Furthermore, hybrid encryption technologies are known, in which symmetric and asymmetric encryption technologies are combined. Asymmetric encryption requires the exchange of two different asymmetric key pairs between a party sending encrypted data and a party receiving encrypted data.

The application of such a hybrid encryption technology is known, for example, from DE 10 2016 109 125 B3.

Exemplary embodiments of the present invention are directed to an improved method for encrypted communication between computer systems, which is characterized by a high level of cyber security and data protection.

A method for encrypted communication between computer systems provides, in accordance with the invention, that
a computing unit provides training data;
the computing unit provides an RSA key pair comprising a private key and a public key;
the computing unit stores the public key in a key store of an external training unit;
the computing unit generates a first AES one-time key;
the computing unit encrypts the training data with the first AES one-time key;
the computing unit encrypts the first AES one-time key with the private key;
the computing unit transmits the encrypted training data and the encrypted first AES one-time key to the training unit;
the training unit tries out all public keys stored in the key store to decrypt the received first AES one-time key until the training unit decrypts the first AES one-time key;
the training unit decrypts the training data with the decrypted first AES one-time key;
the training unit processes the training data;
the training unit generates a second AES one-time key;
the training unit calculates result data in the course of processing the training data and encrypts the result data with the second AES one-time key;
the training unit encrypts the second AES one-time key with the matching public key found in the key store;
the training unit transmits the encrypted result data and the encrypted second AES one-time key back to the computing unit; and
the computing unit decrypts the second AES one-time key with the private key and decrypts the result data with the decrypted second AES one-time key.

This provides a communication method that is particularly secure in terms of cyber security and data protection, and at the same time uncomplicated. Only the computing unit and the training unit are required for the key exchange, which allows the method according to the invention to be carried out using a comparatively simple hardware structure. The method according to the invention can therefore be implemented simply and cost-effectively.

The training unit is a computer system separate from the computing unit. By way of example, it can be a computer system in the form of a desktop computer, a server, a laptop or similar. The training unit is used to read in and process the training data.

According to a particularly advantageous embodiment of the method, the processing of the training data by the training unit comprises the training of a machine learning model. Proven learning methods, such as reinforcement learning, for example, can be used for this purpose. The training data can then contain measurement data and target result data, wherein the machine learning model is trained to deliver corresponding target result data depending on the measurement data. After the training process, only new measurement data can be fed to the machine learning model, wherein the machine learning model is then able to derive result data from this due to the training. Taking this purpose into account, the data processed by the computing unit and the training unit are called training data and result data. In general, however, it is simply computer-readable data. The designation as training data and result data is merely used to distinguish between the two data sets.

In the following, the processing of the training data and generation of the result data is always described in the context of training the machine learning model. However, it should be noted that data processing can generally also take place for other reasons and in other contexts.

Preferably, the training unit comprises particularly powerful hardware components, such as powerful single or multi-core CPUs and powerful graphics processors, also known as graphics processing units (GPUs). In particular, the training unit is a component of a backend. This will be discussed later. With the help of powerful hardware, the processing time of data can be accelerated with the aid of artificial intelligence.

The training unit can receive training data from a plurality of different computing units. Accordingly, the public keys of these computing units are stored in the key store of the training unit. The training data is processed in such a way that no references to specific persons or to the respective computing unit itself are possible. When the public key of the computing unit is stored in the key store, no information is stored that would allow conclusions to be drawn as to which public key originates from which computing unit with the RSA method for specific users. This ensures that anonymous transmission of training data between the computing unit and the training unit is possible.

The training unit therefore has no information about which public key must be used to decrypt the encrypted first AES one-time key received from the computing unit. This is essential to ensure data protection. Accordingly, the training unit must try all the public keys stored in the key store for decryption. Although this increases latency, there is no need to provide separate computing units involved in the encryption process, which means that fewer computer systems need to be protected against attacks. This reduces the risk of data leaks.

By encrypting the training data with the first AES one-time key, the training data forms sensitive data that must be protected against access by unauthorized persons.

The method according to the invention not only allows machine learning models to be trained (or data to be transmitted) in compliance with data protection regulations, but also allows results generated during the training process (or result data in general) to be transmitted back to the corresponding computing unit that supplied the training data in compliance with data protection regulations. The result data can be either the trained machine learning model itself or the final result calculated by the machine learning model. In this way, the training data can represent input variables for the machine learning model, whereupon the machine learning model calculates a final result. The input data can be camera images, for example, in which the machine learning model recognizes and classifies objects as the final result.

A novel feature of the method according to the invention is that no two different RSA key pairs are exchanged for encrypted communication between the training unit and the computing unit, but rather the RSA key pair generated by the computing unit is used to decrypt and encrypt both messages sent by the computing unit and messages sent by the training unit. This ensures particularly efficient data processing.

The method according to the invention for encrypted communication can be used in the following method for the secure storage of data, which provides that
at least two different users log on to a group device at different times with a username and user-specific password;
while a user is logged in to the group device, user-specific training data is collected from the group device and stored as sensitive data, wherein access to sensitive data is protected by the username and password.

The group device can be used by different users. By using individual usernames and user-specific passwords, each user only has access to the training data they have generated themselves. This ensures data protection, as users cannot view any personal data of other users. The group device does not give any user the opportunity to read, let alone manipulate, the personal data of another user.

The group device is a computing unit within the meaning of the invention, such as a mobile end device, an embedded system, for example implemented as a so-called system on a chip (SoC), a desktop computer, a server or the like.

The training data is, in particular, data accrued during the use of the group device or a system superior to the group device. By way of example, the group device can be integrated into a vehicle. The training data then describes data generated in connection with the user of the vehicle, such as the manner in which vehicle components are operated, the user's driving behavior, the route taken, data generated by the vehicle using sensors, and the like. By way of example, the vehicle can use sensors to detect its surroundings. The vehicle can use cameras, laser scanners, radar sensors, ultrasonic sensors, microphones, and the like as sensors. The data collected by the vehicle and shared with or stored in the group device can also relate to vehicle subsystems, such as the system behavior of control units, air, water or oil temperature, wheel speed, pump speed and the like.

In particular, the training data and sensitive data are stored in the group device in a cryptographically encrypted form. The username and password are then required for decryption in the group device. For transmission to the backend (training unit) and/or a frontend (individual device—see the following paragraphs), the data to be exchanged is secured using the encrypted communication method according to the invention.

The method for secure data storage can also provide that
a respective user logs in to a user-specific individual device with their username and password, wherein, while the user is logged in to the individual device, user-specific training data can be collected from the individual device and stored as sensitive data in the individual device;
each individual device establishes a pairing with the group device; and
each individual device performs data synchronization with the group device, wherein exclusively the sensitive data generated by the respective user themselves is synchronized between the user's individual device and the group device.

The linking of individual devices with the group device increases the design freedom when exchanging data. The link can be established directly, or indirectly via the backend. Each user has their own individual device. The individual device can preferably be a mobile device such as a smartwatch, smartphone, tablet computer, laptop or similar. Coupling between the group device and the individual device, particularly in a vehicle, is possible in a variety of tried and tested ways. Wired coupling techniques, for example via Ethernet cable or USB cable, as well as wireless coupling techniques, for example using Wi-Fi, Bluetooth, ZigBee, NFC and the like, are possible. In long-distance range, coupling including data synchronization is possible via mobile radio with, for example, 3G, 4G, 5G, etc.

Training data and sensitive data can be generated and stored both in an individual device and in a group device. During synchronization, data generated in one device is exchanged with the other device and duplicated, such that the corresponding training data and sensitive data is available in both the individual device and the group device. Since only the training data or sensitive data of the respective user is transferred, i.e., used for their own use and made accessible, data protection is further improved. This prevents the training data of a first user from being transferred to the individual device of a second user.

As training data can also be generated with the individual device, a first user can generate training data with their individual device while a second user is logged on to the group device. This is the case, for example, if the second user is travelling in a vehicle containing the group device. This makes it possible to generate even more comprehensive personal training data and to jointly use non-personal training data and events to improve the vehicle-specific and safety-relevant behavior and reaction models that apply to everyone when driving and parking.

In a particularly advantageous embodiment, the group device is a vehicle-integrated computing unit such as the control unit of a vehicle subsystem, for example the infotainment system, or a central on-board computer, and the user-specific individual devices are the respective smartphones of vehicle occupants. In this context, the group device can also be referred to as an onboard system and the individual devices as offboard systems.

Non-personal training data and event data for improving vehicle-specific and safety-relevant behavior and reaction models that apply to everyone can also be used jointly, as sharing this does not compromise data protection.

The onboard system can advantageously be paired with a respective individual device as a frontend for operating and displaying personal data outside the vehicle by linking it to the user account in the backend, such that the individual device can be used as trustworthy for the vehicle and the backend when transferring personal training data and predicted results without the onboard system running via the backend, where machine learning models are stored and machine learning takes place.

An advantageous design of the method according to the invention for encrypted communication between computer systems provides that, after training the machine learning model, the training unit stores it in an external machine learning model storage unit and then deletes all training data, the first AES one-time key, and the trained machine learning model. The machine learning model is stored in an non-personalized form. This further improves data security and data protection. To train the machine learning model, relevant information is only retained during the actual training process in the training unit. Afterwards, the corresponding relevant data is deleted. The machine learning model storage unit serves as a data storage for trained and non-personalized machine learning models. The machine learning model storage unit can be formed by a separate computer system such as a desktop computer, a server or a server network. The training unit and the machine learning model storage unit can be integrated into a common network, for example a common Local Area Network (LAN). Communication between the training unit and the machine learning model storage unit can also take place via the Internet.

Preferably, the training unit reads out an existing machine learning model from the machine learning model storage unit and continues training it with the training data. In general, it would be possible to store machine learning models in the training unit. In this case, the training unit can easily continue training various machine learning models. However, a particularly high level of data security is possible when using the machine learning model storage unit. In this case, the training unit can either train a new machine learning model initially with the training data without accessing the machine learning model storage unit, or it can read out an already trained machine learning model and continue training it. This makes it possible to train the same machine learning model or different machine learning models for a group of individuals. For this purpose, user-specific or individual-specific training data is collected and used for training. This enables data protection-compliant and anonymous further training of the machine learning models in question.

According to another advantageous embodiment of the method for encrypted communication according to the invention, an end device integrated into a vehicle in the form of a group device or a mobile end device external to the vehicle in the form of an individual device is used as a computing unit. This further increases data protection for training the machine learning model. In this way, training data from different users can be generated and taken into account with one and the same computing unit, non-personalized machine learning models in the onboard and backend system for vehicle-specific and safety-relevant behavior and reaction models that apply to all can be jointly used, while personalized machine learning models and end results can only be decrypted and displayed via individual devices or with their private keys protected by usernames and user-specific passwords in the onboard system. In particular, the user-specific RSA key pair is then generated by the group device (for the respective logged-in user), preferably by a respective individual device. By way of example, the RSA key pairs can be generated individually for each user from a smartphone, and the corresponding private keys and public keys can be distributed to the group device for storage during synchronization. This enables the group device to transmit training data to the training unit on behalf of the individual devices and, accordingly, to decrypt and process any results received.

An advantageous further development of the method also provides that the computing unit stores the RSA key pair in an external RSA key storage unit after it has been generated. The RSA key storage unit is particularly well protected cryptographically against compromise by unauthorized users. The RSA key storage unit is used to recover lost keys. RSA key pairs stored in the RSA key storage unit can also be updated if the original keys have changed.

In this way, the computing unit, in particular an individual device or group device, can contact the RSA key storage unit and, after transmitting the username and user-specific password, restore the user's RSA key pair.

A further advantageous embodiment of the method according to the invention also provides that
an individual device transmits a wake-up command to a sleeping group device, whereupon the group device is awakened from standby mode;
the encrypted result data and the encrypted second AES one-time key are forwarded from the individual device to the group device; and
the group device decrypts the second AES one-time key with the private key and decrypts the result data with the decrypted second AES one-time key.

As already mentioned, an individual device or the group device can generally function as a computing unit, such that the result data can be decrypted by the individual device or the group device anyway. However, it can also happen that the result data is specifically relevant for the group device, but not for the individual device. Furthermore, the group device can have a sleep mode or standby mode. The group device can then be woken up by an individual device issuing a wake-up command and used to perform the relevant method steps. In such a case, the training data may have been transmitted from the individual device to the training unit.

In accordance with the invention, a vehicle comprises a group device described above. The group device is designed to carry out the method according to the invention for securely storing data and to carry out the method according to the invention for encrypted communication between computer systems. The vehicle can be any vehicle such as a passenger car, lorry, van, construction machine or similar. Generally, it can also be a rail vehicle, watercraft or aircraft.

Further advantageous designs of the method and the vehicle according to the invention emerge from the exemplary embodiments, which are described in more detail below with reference to the figures.

### BRIEF DESCRIPTION OF THE DRAWING FIGURES Here are shown:

FIG. 1 a schematic representation of a system for training a machine learning model in compliance with data protection regulations; and

FIG. 2 a flow chart of a method according to the invention.

### DETAILED DESCRIPTION

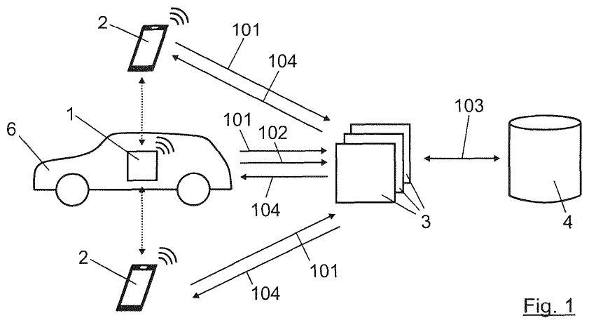

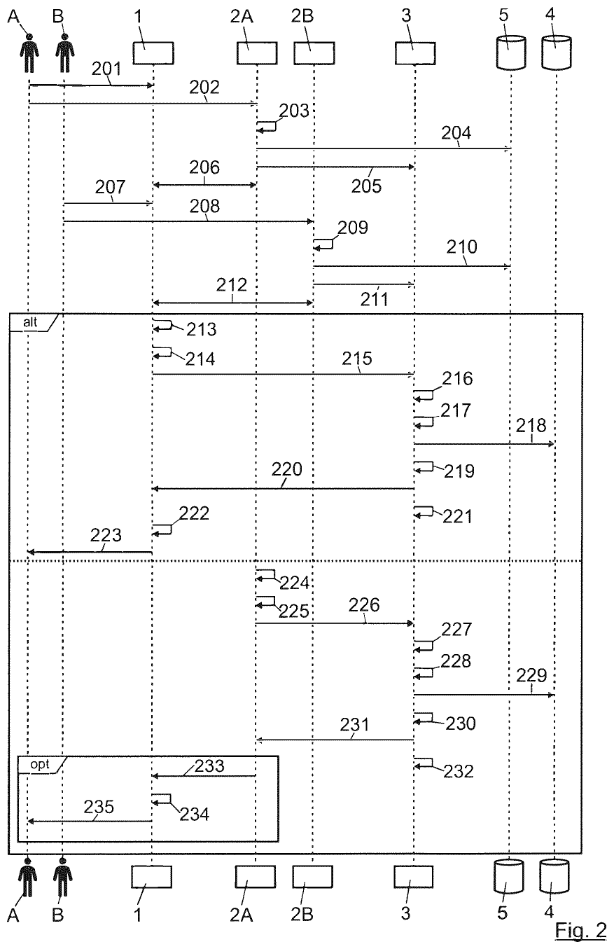

For training machine learning models, also referred to a machine learning, data sets of comparable size are needed. Typically, users A and B depicted in FIG. 2 generate training data used for this purpose. This training data can allow conclusions to be drawn about user behavior, which jeopardizes the data protection of users A and B. The aim of a method in accordance with the invention for encrypted communication between computer systems in the context of training a machine learning model is therefore to maintain data protection and cyber security. A system suitable for this is depicted in FIG. 1.

According to one possible embodiment, the system comprises a group device 1 integrated in a vehicle 6, which group device 1 is also referred to as an onboard system, for example a central onboard computer. The group device 1 is paired with a user-specific individual device 2 for each user A and B, ensuring trustworthy communication between the shared onboard system and the individual devices during further method steps. The group device 1 and/or the individual devices 2 can be used to generate training data, which is stored as sensitive data in the corresponding group device 1 and individual device 2, protected from unauthorized access by a username and user-specific password. The group device 1 and the individual devices 2 can synchronize such that training data is duplicated and stored in both devices. Only training data generated by the respective user is transferred to the individual device 2 of that user.

As indicated by an arrow 101, personal data can be transmitted in encrypted form to a training unit 3. The system according to the invention can have several training units 3, which allows for massive data processing. As indicated by an arrow 102, data that does not allow any conclusions to be drawn about a specific person or device can be transmitted to said training unit 3.

The training unit 3 is generally used for data processing or, in the context discussed here, for training one or more machine learning models. The training data used for training is preferably only stored in the training unit 3 for as long as the machine learning model itself is being trained. The training data is then deleted. The system also comprises a machine learning model storage unit 4. As indicated by an arrow 103, a respective training unit 3 can exchange machine learning models with the machine learning model storage unit 4. This allows newly and initially trained machine learning models to be stored in the machine learning model storage unit 4, and machine learning models that have already been trained to be obtained and thus further trained in the training unit 3. Accordingly, further trained machine learning models can be transferred back to the machine learning model storage unit 4. Results obtained during training, for example a fully trained machine learning model or the final result calculated by the machine learning model during training, can be transferred back to the corresponding group device 1 and/or individual device 2 in encrypted form, as indicated by an arrow 104.

FIG. 2 shows the method sequence in detail.

The flow chart depicted in FIG. 2 depicts a user A, a user B, the group device 1, the individual device 2A of the user A, the individual device 2B of the user B, the training unit 3, the machine learning model storage unit 4, and an RSA key storage unit 5.

In a step 201, the user A starts and registers for the first time on the group device 1 or logs in with their username and password. In step 202, the user A starts and registers or logs in on their individual device 2A.

In step 203, the individual device 2A generates the RSA key pair associated with the user A, i.e., the private and public keys. In the optional step 204, these public and private keys are stored in the RSA key storage unit 5 as a backup. In the step 205, the public key is stored in the training unit 3 without any information that could reveal the user identity or device identity, and is saved there in the key store. There can already be a plurality of other public keys from other computing units located in the key store.

In step 206, the group device 1 and the individual device 2A of the user A are paired. This involves synchronizing personal data, including the RSA key pair generated by the individual device 2A.

In step 207, the user B starts and registers or logs on to the group device 1. In the method step 208, the user B starts and registers or logs in to their individual device 2B.

The procedure is analogous to that for user A. In step 209, the RSA key pair for the user B is generated and, optionally, transferred in step 210 to the RSA key storage unit 5 for emergency recovery of said keys. In step 211, the public key of the user B is also stored in the key store of the training unit 3 without any information that could be used to draw conclusions about the identity of user B.

In step 212, the individual device 2B is then synchronized with the group device 1.

Two alternatives are depicted below that show how training data can be exchanged with the training unit 3 to train a machine learning model. According to steps 213 to 223, training data is transmitted from the group device 1. According to steps 224 to 232, however, the training data is transmitted from the individual device 2A of the user A.

In step 213, the group device 1 generates a first AES one-time key. In step 214, training data is encrypted with the first AES one-time key and then the first AES one-time key is encrypted with the private key of the user A. In this case, the private key of the user A is used, as the user A is currently logged in to the group device 1. In general, however, the key of the logged-in user in each case is used here.

In step 215, the encrypted training data and the encrypted first AES one-time key are transmitted to the training unit 3.

In step 216, the training unit 3 applies all public keys stored in the key store, i.e., those obtained from any number of computing units, to the data received in this way in order to decrypt it. At some point, the correct key is found, which allows the first AES one-time key to be decrypted. In step 217, the training data is decrypted with the decrypted first AES one-time key. The machine learning model is then trained. In step 218, the machine learning model trained in this way can be stored in the machine learning model storage unit 4. If a machine learning model is not initially retrained, an existing machine learning model could also be loaded from the machine learning model storage unit 4 before training in order to train it further (not depicted). The result data calculated by applying or training the machine learning model is encrypted in step 219. To do this, the training unit 3 generates a second AES one-time key and uses it to encrypt the result data. The second AES one-time key is then encrypted with the public key found in the previous step. In step 220, the encrypted result data and the encrypted second AES one-time key are then transmitted back to the group device 1.

In step 221, the training unit 3 then deletes all relevant data, such as the trained machine learning model, the training data used and the first AES one-time key. This means that the relevant information can no longer be manipulated or stolen in the event of an attack, which improves cyber security and data security accordingly.

In step 222, the group device 1 decrypts the second AES one-time key with the private key. The group device 1 then uses the decrypted second AES one-time key to decrypt the result data obtained from the training unit 3. In step 223, the result contained in the result data is output to the user A, for example in processed form.

The procedure using the individual device 2A is analogous. In step 224, the individual device 2A generates the first AES one-time key. In step 225, the individual device 2A encrypts the training data with the first AES one-time key and then encrypts this in turn with the private key. In step 226, the encrypted training data and the encrypted first AES one-time key are transmitted to the training unit 3.

In step 227, the training unit 3 decrypts the first AES one-time key with a matching public key read out from the key store. In step 228, the training unit 3 then decrypts the encrypted training data with the first AES one-time key decrypted in this way. This is followed by the training of the machine learning model. In the optional step 229, the machine learning model trained in this way can be stored in the machine learning model storage unit 4. Analogously, a previously trained machine learning model could also be loaded here (not depicted) in order to train it further.

In step 230, the training unit 3 generates a second AES one-time key and uses it to encrypt the result data generated during training of the machine learning model. The second AES one-time key is then encrypted with the public key found in the previous step. In step 231, the encrypted result data and the encrypted second AES one-time key are then transmitted back to the individual device 2A of the user A. In step 232, the training unit 3 deletes the relevant data, i.e., the trained machine learning model, the training data and the first AES one-time key.

The decrypted result data or results can then be output to the user. This can be done via the individual device 2A or the group device 1. An optional special case is described below, in which an output occurs via the group device 1, wherein this is currently in standby mode. The sleeping group device 1 is awakened by the individual device 2A to enable the output of the results. To do this, the individual device 2A sends a wake-up command to the sleeping group device 1 in the step 233. The individual device 2A then forwards the encrypted result and the encrypted second AES one-time key to the group device 1. In step 234, the group device 1 decrypts said data. To do this, the group device 1 decrypts the second AES one-time key with the private key and the encrypted result with the decrypted second AES one-time key obtained in this way. In step 235, the output is then sent to the user A.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-8. (canceled)

9. A method for encrypted communication between computer systems, the method comprising:
providing, by a computing unit, training data;
providing, by the computing unit, an RSA key pair comprising a private key and a public key;
storing, by the computing unit, the public key in a key store of an external training unit;
generating, by the computing unit, a first AES one-time key;
encrypting, by the computing unit, the training data with the first AES one-time key;
encrypting, by the computing unit, the first AES one-time key with the private key;
transmitting, by the computing unit to a training unit, the encrypted training data and the encrypted first AES one-time key;
trying, by the training unit, all public keys stored in the key store to decrypt the received first AES one-time key until the training unit decrypts the first AES one-time key;
decrypting, by the training unit, the training data with the decrypted first AES one-time key;
processing, by the training unit, the training data;
generating, by the training unit, a second AES one-time key;
calculating, by the training unit, result data in the course of processing the training data and encrypting the result data with the second AES one-time key;
encrypting, by the training unit, the second AES one-time key with the matching public key found in the key store;
transmitting, by the training unit to the computing unit, the encrypted result data and the encrypted second AES one-time key; and
decrypting, by the computing unit, the second AES one-time key with the private key and decrypting the result data with the decrypted second AES one-time key.

10. The method of claim 9, wherein the processing of the training data using the training unit comprises training a machine learning model.

11. The method of claim 10, wherein the training unit stores the machine learning model in an external machine learning model storage unit after training the machine learning model, and then deletes all training data, the first AES one-time key, and the trained machine learning model.

12. The method of claim 11, wherein the training unit reads out an existing machine learning model from the machine learning model storage unit and continues to train the existing machine learning model with the training data.

13. The method of claim 9, wherein the computing unit is an end-device integrated into a vehicle in the form of a group device or a mobile end device external to the vehicle in the form of an individual device.

14. The method of claim 13, wherein the computing unit stores the RSA key pair in an external RSA key storage unit after the RSA key pair has been generated.

15. The method of claim 14, wherein
an individual device transmits a wake-up command to a sleeping group device, whereupon the group device is awakened from standby mode;
the encrypted result data and the encrypted second AES one-time key are forwarded from the individual device to the group device; and
the group device decrypts the second AES one-time key with the private key and decrypts the result data with the decrypted second AES one-time key.

16. A vehicle comprising:
a group device used in a method 13.
